(19) United States
(12) Patent Application Publication
(10) Pub. No.: US 2025/0297450 A1
(43) Pub. Date: Sep. 25, 2025

(54) Electric Construction Machine

(71) Applicant: Wacker Neuson Produktion check here, Reichertshofen (DE)

(72) Inventor: Markus Falzberger, Pupping (AT)

(21) Appl. No.: 19/086,843

(22) Filed: Mar. 21, 2025

(30) Foreign Application Priority Data
Mar. 25, 2024 (EP) 24165894

(51) Int. Cl. E02F 9/08; B60L 15/00; B60L 50/60; E02F 3/32; E02F 9/12; E02F 9/16; E02F 9/22

(52) U.S. Cl. CPC E02F 9/0866; B60L 15/007; B60L 50/66; E02F 3/325; E02F 9/0891; E02F 9/121; E02F 9/16; E02F 9/2203; E02F 9/2217

(57) ABSTRACT

An electric construction machine has a working unit and a superstructure. An electric motor for driving a drive train and/or the working unit and an electric energy storage device for supplying the electric motor with electric energy are arranged in the superstructure. In order to allow flexible installation of the components located in the superstructure despite a compact, simple and weight-saving design, without compromising stability and construction machine operation, a main axis of the energy storage device of the electric energy storage device extends obliquely to the longitudinal axis of the superstructure.

### BACKGROUND

### 1. Field of the Invention

The invention relates to an electric construction machine with a working unit and with a superstructure, in which is arranged an electric motor for driving a drive train and/or the working unit and an electric energy storage device for supplying the electric motor with electric energy.

### 2. Discussion of the Related Art

For confined construction site applications, efforts are being made to produce construction machinery that is as compact as possible. Electric construction machines without rear overhang, such as zero tail excavators are already known from the state of the art, such as EP4306724A1. To ensure that the superstructure of the construction machine is sufficiently compact, the axis of rotation of the electric motor and the longitudinal axis of the hydraulic pump are arranged parallel to a vertical axis, which is to say, vertically. In this way, the height of the superstructure can be taken advantage of to the benefit of a compact length and width of the superstructure. The disadvantage thereof, is, however, that this results in restrictions with regard to the unrestricted orientation of the electric motor and the hydraulic pump, which can lead to the need of special designs of these components and complex contacting and routing of the hydraulic lines.

A further requirement, in particular, for electric construction machinery is that it should be as light as possible in order to enable resource-saving work assignments. Due to the desired low dead weight of such construction machinery, bracing is required to increase stability in the superstructure, but this requires mutual adaptation of the components and of the bracing in the superstructure, which in some cases requires complex constructions. In particular, in the case of light construction machinery with a rotational function about a slewing ring, the additional problem arises that the heavy components in the superstructure must be arranged close to and evenly distributed about the center point of the slewing ring, in order to enable a gentle and smooth rotational function during operation of the construction machinery. These boundary conditions in turn make it more difficult to achieve a compact arrangement of the components in the superstructure.

### SUMMARY

The invention is thus based on the task of proposing an electric construction machine of the aforementioned type which, despite its compact, simple and weight-saving design, allows flexible installation of the components located in the superstructure without compromising stability and construction machine operation.

The invention solves the problem by providing a main axis of the energy storage device of the electric energy storage device that extends obliquely to the longitudinal axis of the superstructure. As a result of the features according to the invention, an easily accessible free space is created in the superstructure in which the necessary components of the construction machine can be arranged. In contrast to the state of the art, the energy storage device does not need to be arranged centrally in relation to the superstructure width in order to achieve uniform weight distribution, so that the remaining superstructure that is not occupied by the energy storage device is divided into two relatively small free spaces, namely to the left and right of the energy storage device, but rather the energy storage device, for example, a battery pack, can be arranged off-center in relation to the superstructure width. Due to the oblique orientation of the main axis of the energy storage device, the center of gravity of the energy storage device, even if it leads into a corner of the superstructure, is arranged sufficiently close to the center of the superstructure so that no uncompensated weight distribution results. In the case of an arrangement of the energy storage device on the wall side in the corner of the superstructure, wherein the main axis of the energy storage device is oriented parallel to the longitudinal axis of the superstructure, similar positive spatial conditions would be created, however the more off-center center of gravity of the energy storage device would lead to less favorable weight distribution and thus to less favorable construction machine operation. The oblique orientation of the main axis of the energy storage device also has the advantage that bracing can extend along the energy storage device to strengthen the superstructure walls. Kinks needed in order to avoid the energy storage device system and that weaken the bracing can be dispensed with, which means that the bracing can not only be simpler in design, but also more stable, which favors lightweight superstructure designs. The fact that the obliquely oriented energy storage device can be arranged predominantly on one side of the superstructure results in a contiguous free space on the other side, which provides sufficient space for the other components typical of an electric construction machine. Typical components can be an electric motor, a hydraulic pump, an inverter, an oil tank, a cooling device, a hydraulic control block, a rotary drive for a slewing ring and a slewing ring. The energy storage device may be arranged in the rear area of the superstructure and oriented in the direction of a superstructure rear deck. In the context of the invention, the main axis of the energy storage device can be the longitudinal axis of the energy storage device. In particular, the main axis of the energy storage device or respectively the longitudinal axis of the energy storage device and the longitudinal axis of the superstructure lie in a horizontal plane. In the context of the invention, oblique to the longitudinal axis of the superstructure means deviating from a line extending transversely to the longitudinal axis of the superstructure at an acute or obtuse angle. Accordingly, the main axis of the energy storage device does not extend orthogonally to the longitudinal axis of the superstructure, but rather at an angle not equal to 90°. The electric construction machine can be an excavator, in particular an excavator without rear overhang, with an excavator arm as the working unit. The construction machine can comprise an undercarriage with the drive train and a superstructure attached to the undercarriage comprising the working unit and an operator compartment.

Particularly advantageous spatial conditions result when the main axis of the energy storage device and the longitudinal axis of the superstructure enclose an angle of between 40°-15°, and more typically between 30°-18°. Surprisingly, it has been found that this not only results in an uninterrupted free space, which enables particularly favorable spatial conditions for flexible installation of the construction machine components on the side opposite the energy storage device, but also enables smooth rotation of the superstructure by means of a slewing ring, since the center of gravity of the energy storage device arranged in this way ensures uniform weight distribution in the superstructure.

In order to comply with the requirements relating to stability and robustness of the construction machine, despite its lightweight construction and to make this possible with the simplest possible design, it is proposed that a continuous bracing extend parallel to the main axis of the energy storage device is provided between a front wall and an adjoining side wall of the superstructure. This bracing may connect the front wall to the side wall. In this way, the bracing, which can form a triangle with the front wall and the side wall, can be designed without kinks, which creates favorable force transfer conditions. The bracing, for example, a sheet metal web, can be connected to the superstructure floor. In the context of a particularly compact design, the distance between the bracing and the energy storage device can be less than the height of the bracing. The distance maybe less than 50% of the height of the bracing. In the case of a bracing with ascending or respectively descending sections, the average height of the bracing in the overlap area between the bracing and the energy storage device side wall can be used. The bracing can spatially divide the superstructure. The electric energy storage device can be located on one side of the bracing. Advantageous functional relationships between the components can be achieved if the electric motor and also the hydraulic pump driven by it are also located on the same side. The cooling device and/or the hydraulic control block and/or the hydraulic oil tank and/or the rotary drive for the slewing ring and/or the slewing ring can likewise be located on this side. The DC converter for the onboard electrical system and/or the electronic control unit and/or a hydraulic pressure accumulator can be located on the other side of the bracing.

In the case of a construction machine comprising a slewing ring which has a center point of the slewing ring for rotating a superstructure of the construction machine about an axis of rotation relative to the drive train, a particularly uniform construction machine operation is achieved if the center of gravity of the electric energy storage device is arranged in the superstructure on the side opposite the working unit with respect to the longitudinal axis of the superstructure passing through the center point of the slewing ring. In this way, both the working unit and the center of gravity of the energy storage device are arranged off-center-but on different sides of the center point of the slewing ring-along the width of the superstructure and counterbalance each other.

In order to enable simple and rapid maintenance of the electric energy storage device, a side wall and an adjoining rear wall of the superstructure can be formed, at least in sections, by a swing-out access flap. By opening what may be common access flap of the side and rear wall, not only the rear area but also the side area of the superstructure is opened at least in sections, so that the electric energy storage device, which is, in particular, arranged with one of its corners in the area of the side wall and with one of its corners in the area of the rear wall of the superstructure, can be removed from the superstructure in the direction of the main axis of the energy storage device. This is facilitated, in particular, if the projection surface of the access flap projected in the direction of the main axis of the energy storage device is larger than the projection surface of the energy storage device projected in the direction of the main axis of the energy storage device and if the projection surface of the energy storage device lies completely within the projection surface of the access flap.

To ensure that not only space-saving but also low-loss current conversion conditions prevail in the superstructure, it is provided that the electric energy storage device is assigned an inverter, the longitudinal inverter axis of which extends parallel to the main axis of the energy storage device. In this way, the inverter can be arranged adjacent to the energy storage device side wall, resulting in particularly short electrical contact paths. Advantageously, the energy storage device can be located together with the inverter in the flow area of the construction machine cooling system, whereby both components are exposed to the same cooling conditions, which can lead to slower ageing of the components.

In one embodiment, the inverter can form a common assembly with the electric motor, the axis of rotation of which extends parallel to the main axis of the energy storage device. The inverter can be mounted on the electric motor by means of a web so that both components can be arranged adjacent to the energy storage device side wall. The orientation of the axis of rotation parallel to the main axis of the energy storage device can occur regardless of whether the electric motor forms a common assembly with the inverter.

In another embodiment, the electric motor can form an axis of rotation extending parallel to a normal axis that is normal to the superstructure floor. An analogous advantage arises if a hydraulic control block is provided in the superstructure, the longitudinal axis of which extends parallel to this normal axis. In the case of a horizontal orientation of the superstructure floor, the normal axis is the vertical axis. The hydraulic control block can be arranged adjacent to an energy storage device side wall that extends substantially at right angles to the bracing.

Construction machines conventionally have a superstructure with an operator compartment in which an operator seating area is arranged. In order to be able to reduce the length of the construction machine, it is proposed that an operator seating area superimposes, at least in sections, a projection surface projected in the direction of the vertical axis of the electric energy storage device.

An advantageous reduction in the overall height of the construction machine can be achieved by arranging a floor section of the electric energy storage device below a floor area of an operator compartment of the superstructure. In particular, the electric energy storage device can be arranged with at least 10%, more typically 20%, and even more typically 30% of its total height below the floor area of the operator compartment of the superstructure.

### BRIEF DESCRIPTION OF THE DRAWINGS

The drawing shows the object of the invention by way of example, in which:

FIG. 1 shows a schematic side view of an electric construction machine according to the invention,

FIG. 2 shows a schematic top view of a section of a superstructure of an electric construction machine according to the invention,

FIG. 3 shows a perspective view of a section of a superstructure of an electric construction machine according to the invention, and

FIG. 4 shows a perspective view of an assembly comprising an electric motor and an inverter.

### DETAILED DESCRIPTION

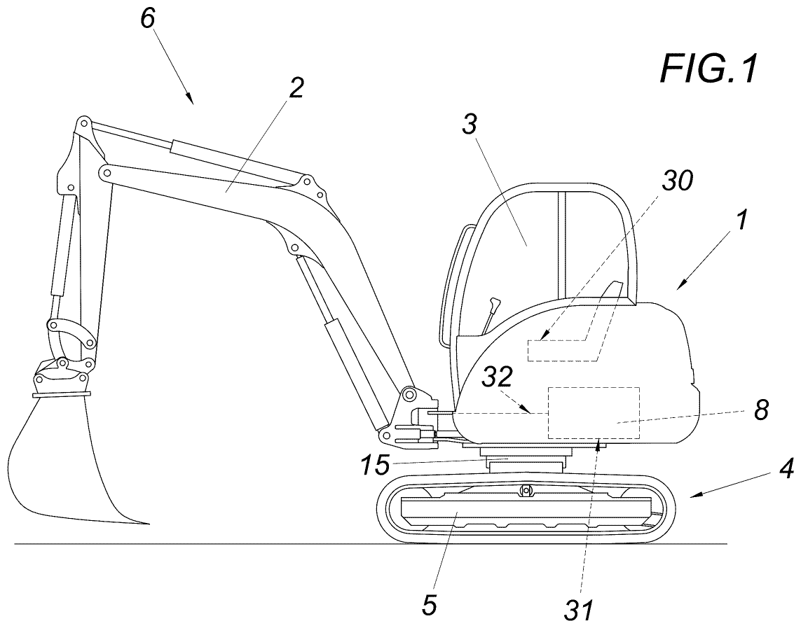

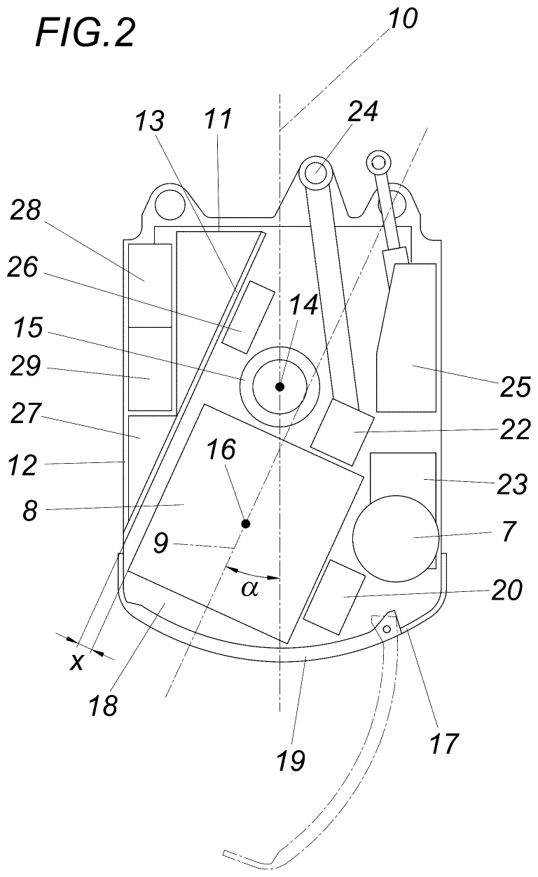

A construction machine according to the invention is shown in FIG. 1 and comprises a superstructure 1 with a working unit 2 and an operator compartment 3. The superstructure 1 is arranged to rotate relative to an undercarriage 4 about an axis of rotation on the undercarriage. The undercarriage 4 comprises a drive train 5. The construction machine can be an excavator 6. An electric motor 7 for driving the drive train 5 and/or the working unit 2 can be provided in the superstructure 1, as shown, for example, in FIG. 2. An energy storage device 8 is used to supply electric energy to the electric motor 7. According to the invention, the main axis of the energy storage device 9, namely the longitudinal axis of the energy storage device of the electric energy storage device 8, is arranged to extend oblique to the longitudinal axis of the superstructure 10. The main axis of the energy storage device 9 and the longitudinal axis of the superstructure 10 extend in a common horizontal plane, which in FIG. 2, extends parallel to the image plane. This results in advantageous spacial and weight distribution conditions in the superstructure 1, in particular, when the main axis of the energy storage device 9 and the longitudinal axis of the superstructure 10 enclose an angle a of between 22°-18°, more typically 20°.

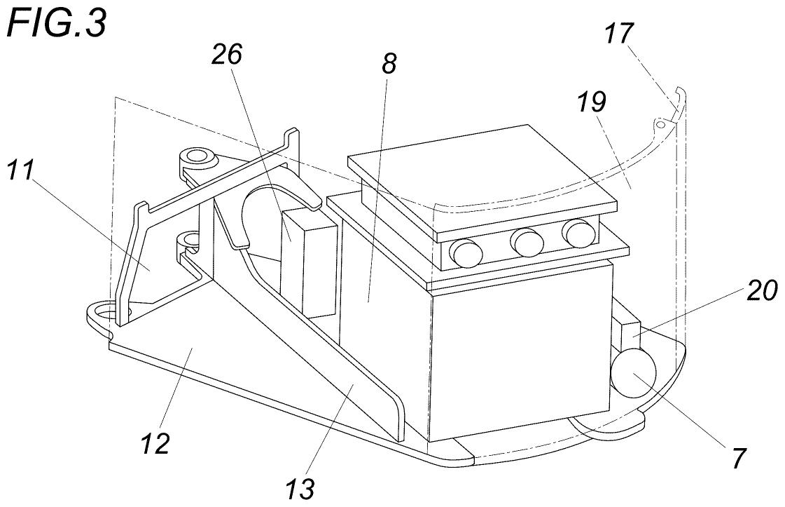

It can be seen in FIG. 2 and FIG. 3 that a bracing 13 extends between a front wall 11 and an adjoining side wall 12 of the superstructure 1, forming a triangle together with the front wall 11 and the side wall 12 when viewed from above. The bracing 13 extends parallel to the main axis of the energy storage device 9 in a continuous manner, which is to say, without kinks, which results in an advantageous force transfer. In particular, the greatest distance x of the bracing 13 from the energy storage device 8 can be less than the height of the bracing 13 in the area of the energy storage device 8, as this is indicated in FIG. 3.

To rotate the superstructure 1 relative to the undercarriage 4, the construction machine can comprise a center point of the slewing ring 14 having a slewing ring 15. In order to achieve a beneficial weight distribution and smooth rotatability of the superstructure 1, the center of gravity 16 of the electric energy storage device 8 can extend on one side of the longitudinal axis 10 of the superstructure passing through the center point of the slewing ring 14, and the working unit 2 can be attached to a linkage 24 on the other side.

For a particularly easy accessibility, the energy storage device 8 can be arranged in the rear area of the superstructure 1 and oriented towards the rear of the superstructure. This means that one corner of the energy storage device 8 is arranged in the area of the side wall 12 and one corner in the area of the rear wall 17, so that a maintenance area 18 is created between the energy storage device 8, the side wall 12, and the rear wall in the superstructure. In the area of the side wall 12 or respectively rear wall 17 means that the smallest distance from the energy storage device 8 to the respective wall 12, 17 is less than 15 cm, more typically less than 10 cm. The maintenance area 18 can be reached by means of an access flap 19. The swing-out access flap 19 can thereby form a part of the side wall 12 and a part of the rear wall 17, so that when the access flap 19 is opened, both the side wall 12 and the rear wall 17 are opened in sections.

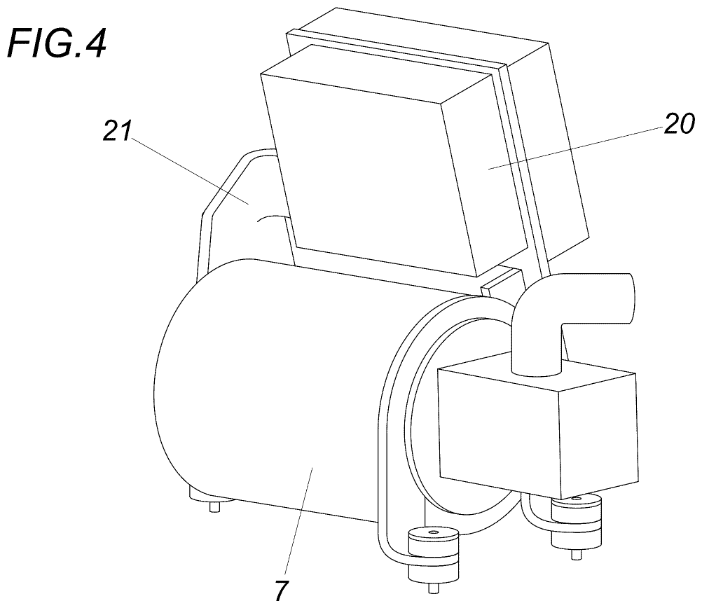

The inverter 20 for the energy storage device 8 can be arranged in the superstructure 1 in such a way that the longitudinal axis of the inverter is oriented parallel to the main axis of the energy storage device 9 (FIG. 2). The inverter 20 can, in particular, be adjacent to the energy storage device side wall in order to utilize a common cooling system. If the axis of rotation of the electric motor 7 is likewise oriented parallel to the main axis of the energy storage device 9, then the inverter 20 can form a common assembly (FIG. 3 and FIG. 4) with the electric motor 7 in a particularly simple way. The inverter 20 can be connected to the electric motor 7 by means of a connecting web 21. An alternative embodiment is suggested in FIG. 2, in which the electric motor 7 forms an axis of rotation parallel to the normal axis, which is normal to the superstructure floor. In the case of a horizontally extending superstructure floor, the normal axis is a vertical axis, which points into the image plane in FIG. 2. In a similar way, a longitudinal axis of a hydraulic control block 22 can also extend parallel to the normal axis or alternatively vertical axis.

FIG. 2 shows that the bracing 13 can spatially divide the superstructure 1. The electric energy storage device 8, the electric motor 7, the hydraulic pump 23 driven by it, the cooling device (not shown), the hydraulic control block 22, the hydraulic oil tank 25, the rotary drive 26 for the slewing ring 15, and the slewing ring 15 can be located on one side of the bracing. The DC converter 27 for the on-board electrical system, the electronic control unit 28 and a hydraulic pressure accumulator 29 can be located on the other side of the bracing 13. For the sake of simplicity, the components are only shown schematically in the figures.

It can be seen from FIG. 1, that an operator seating area 30 superimposes, in sections, a projection surface of the electric energy storage device 8 projected in the direction of the vertical axis and that a floor section 31 of the electric energy storage device 8 is arranged below a floor area 32 of an operator compartment 3 of the superstructure 1.

1. An electric construction machine comprising:
a working unit; and
a superstructure in which is arranged an electric motor for driving a drive train and/or the working unit, and an electric energy storage device for supplying the electric motor with electric energy,
wherein a main axis of the energy storage device of the electric energy storage device extends obliquely to a longitudinal axis of the superstructure.

2. The electric construction machine according to claim 1, wherein the main axis of the energy storage device and the longitudinal axis of the superstructure enclose an angle of between 40° and 15°.

3. The electric working machine according to claim 2, wherein the main axis of the energy storage device and the longitudinal axis of the superstructure enclose an angle of between 30° and 18°.

4. The electric construction machine according to claim 1, wherein a continuous bracing extends parallel to the main axis of the energy storage device is provided between a front wall and an adjoining side wall of the superstructure.

5. The electric construction machine according to claim 4, wherein the bracing connects the front wall to the side wall.

6. The electric construction machine according to claim 1, wherein the construction machine comprises a slewing ring having a center point about which the superstructure rotates relative to the drive train, and wherein a center of gravity of the electric energy storage device is arranged in the superstructure on a side thereof opposite the working unit with respect to the longitudinal axis of the superstructure passing through the center point of the slewing ring.

7. The electric construction machine according to claim 1, wherein a side wall and an adjoining rear wall of the superstructure are formed, at least in sections, by a swing-out access flap.

8. The electric construction machine according to claim 1, wherein the electric energy storage device is assigned an inverter having a longitudinal inverter axis that extends parallel to the main axis of the energy storage device.

9. The electric construction machine according to claim 8, wherein the inverter forms a common assembly with the electric motor, the axis of rotation of which extends parallel to the main axis of the energy storage device.

10. The electric construction machine according to claim 1, wherein the electric motor forms an axis of rotation extending parallel to a normal axis that is normal to a floor of the superstructure.

11. The electric construction machine according to claim 10, wherein a hydraulic control block is provided in the superstructure, the hydraulic control block having a longitudinal axis which extends parallel to a normal axis that is normal to the superstructure floor.

12. The electric construction machine according to claim 1, wherein an operator seating area superimposes, at least in sections, a projection surface projected in the direction of a vertical axis of the electric energy storage device.

13. The electric construction machine according to claim 1, wherein a floor section of the electric energy storage device is arranged below a floor area of an operator compartment of the superstructure.
